(19) United States
(12) Patent Application Publication
(10) Pub. No.: US 2024/0253649 A1
(43) Pub. Date: Aug. 1, 2024

(54) Methods and Apparatus for Manoeuvring a Vehicle

(71) Applicant: Tevva Motors Ltd, Essex (GB)

(72) Inventors: Asher Bennett, Tilbury (GB); Richard Lidstone-Scott, Tilbury (GB)

(21) Appl. No.: 18/562,521

(22) PCT Filed: May 19, 2022
(86) PCT No.: PCT/GB2022/051264

§ 371 Date: Nov. 20, 2023

(30) Foreign Application Priority Data
May 20, 2021 (GB) 2107246.7

(51) Int. Cl. B60W 50/08; B60W 30/06; B60W 60/00

(52) U.S. Cl. CPC B60W 50/082; B60W 30/06; B60W 60/00256; B60W 60/005; B60W 2520/04; B60W 2540/215; B60W 2556/40

(57) ABSTRACT

In a first aspect, this specification describes a method which comprises receiving, at a stationary vehicle, a user input to cause the vehicle to enter an autonomous mode; highlighting, by a portable user device, subsequent to the vehicle entering the autonomous mode and prior to the vehicle moving, a target location; receiving, by the vehicle, an indication of the target location and a request to travel to the target location; and causing the vehicle to autonomously travel to the target location without human supervision.

### FIELD

The present specification relates to manoeuvring a vehicle capable of human-controlled operation and autonomous operation.

### BACKGROUND

In some instances, vehicles require human operation to function. In other instances, vehicles may be capable of operating autonomously some or all of the time. Autonomous capabilities can be provided for vehicles through a number of different known technologies.

When delivering packages, delivery personnel may use a delivery vehicle which can carry a large number of packages to be delivered. To fulfil a delivery, the delivery personnel may travel to and park their vehicle at a location close to the delivery destination (i.e. within walking distance of the destination). The delivery personnel may then retrieve, from the vehicle, one or more packages to be delivered to the destination, and carry, on foot, the one or more packages to the destination. To fulfil further deliveries, the delivery personnel may then return to their vehicle and repeat this process.

In urban environments, there may be a high density of delivery locations in relatively close proximity to each other. In this case, some of the distances which the delivery vehicle needs to travel in order to fulfil a further delivery may be relatively short.

### SUMMARY

In a first aspect, this specification describes a method which comprises receiving, at a stationary vehicle, a user input to cause the vehicle to enter an autonomous mode; highlighting, by a portable user device, subsequent to the vehicle entering the autonomous mode and prior to the vehicle moving, a target location; receiving, by the vehicle, an indication of the target location and a request to travel to the target location; and causing the vehicle to autonomously travel to the target location without human supervision.

Highlighting the target location may comprise receiving, by the user device, a user input indicating a request for the vehicle to travel to the user device; and determining that a location of the user device at a time when the user input is received is the target location.

The user device may be a key fob.

Highlighting the target location may comprise receiving, via a user input to the user device, an indication of the target location on a map.

The method may comprise generating, based on sensor data received from one or more sensors of the vehicle, a map of the area around the vehicle; sending, to the user device, the generated map; and receiving, via user input to the user device, an indication of the target location on the generated map.

Highlighting the target location may comprise projecting, by the user device, a laser beam directed at the target location, and receiving an indication of the target location may comprise detecting, by a sensor of the vehicle, a point where the laser beam encounters an object; and determining the target location based on the point.

The point may be the target location. Alternatively, determining the target location based on the point may comprise determining that there is no line of sight between the user device and the target location; and extrapolating, from the point and a location of the user device, the target location.

The method may comprise responsive to a determination by the vehicle that the target location is not a suitable location to park the vehicle, communicating an indication that the target location is not suitable. Communicating the indication that the target location is not suitable may comprise sending, to the user device, a message indicating that the target location is not suitable. Determining that the target location is not a suitable location to park may comprise determining that the target area is occupied by another vehicle.

The method may comprise subsequent to travelling to the target location, causing the vehicle to autonomously park within a predefined threshold distance of the target location.

The vehicle may be a delivery vehicle and the method may be a method of operating a delivery vehicle. Additionally, autonomously travelling may comprise navigating public roads to reach the target location.

The user device and the vehicle may communicate over a local network.

The vehicle may autonomously travel to the target location without further communication with the user device.

The method may comprise subsequent to causing the vehicle to autonomously travel to the target location: highlighting, by the portable user device, a second target location; receiving, by the vehicle, an indication of the second target location and a request to travel to the second target location; and causing the vehicle to autonomously travel to the second target location without human supervision.

In a second aspect, this specification describes a system configured to perform any method described with reference to the first aspect, the system comprising a vehicle; and a portable user device. The system may comprise at least one processor and at least one memory including computer program code which, when executed by the at least one processor, causes the system to perform any method described with reference to the first aspect.

In a third aspect, this specification describes a computer-readable storage medium comprising instructions which, when executed by one or more processors, cause the one or more processors to perform any method described with reference to the first aspect.

### BRIEF DESCRIPTION OF THE FIGURES

For a more complete understanding of the methods, apparatuses and computer readable instructions described herein, reference is now made to the following description taken in connection with the accompanying Figures, in which:

FIG. 1 illustrates an example of a vehicle relocation system;

FIG. 2 illustrates an example of a vehicle used in the vehicle relocation system;

FIGS. 3A, 3B and 3C illustrate examples of the user device used in the vehicle relocation system;

FIG. 4 is a flow chart illustrating an example of a method performed by the vehicle in the vehicle relocation system;

FIG. 5 is a flow chart illustrating an example of a method performed by the user device in the vehicle relocation system; and

FIG. 6 is a schematic illustration of an example configuration of a computer system utilised to provide one or more of the operations described herein.

### DETAILED DESCRIPTION

In the description and drawings, like reference numerals may refer to like elements throughout.

This application describes systems and techniques for providing a vehicle relocation system. The vehicle relocation system may allow a user to exit their vehicle, and to highlight a target location to which they would like their vehicle to travel.

In an example, a user travels in the vehicle to a first location. Whilst travelling to the first location, the vehicle is in a user-controlled mode such that the user operates the vehicle to travel to the first location. The user then parks the vehicle at the first location. Parking the vehicle comprises, for instance, the user manoeuvring into a particular location with a suitable orientation, the user controlling the vehicle to come to a stop, the user applying one or more parking brakes, the user turning and/or removing a key from the vehicle, the user causing the vehicle to enter a parking and/or standby mode, the user causing the gearing of the vehicle to disengage the wheels from an engine and/or motor of the vehicle, the user turning off an engine and/or motor of the vehicle, the user de-powering a motor and/or a driving system of the vehicle, the user exiting the vehicle, etc.

Whilst the vehicle is parked (i.e. stationary), the user provides a user input to cause the vehicle to enter an autonomous mode. The user then subsequently, with a portable user device, highlights a target location. The user highlights the target location prior to the vehicle moving, for instance, due to the user returning to the vehicle and operating it under a user-controlled mode, or due to the vehicle moving under the autonomous mode.

The vehicle receives an indication of the target location highlighted by the user, and a request to travel to the target location. The vehicle then autonomously travels to the target location without human supervision.

In some examples, the vehicle is a delivery vehicle, and the vehicle relocation system is used in the process of delivering packages. By allowing autonomous and unsupervised relocation of the vehicle, the user can complete their deliveries whilst the vehicle is autonomously travelling to the target location. The vehicle can then be waiting for the user to travel to the next location or for the user to collect additional packages from the vehicle for delivery. In this way, the efficiency of delivering packages can be improved. For instance, in high density environments in which a significant amount of a user's time is spent travelling short distances in their vehicle, the techniques and systems described herein could provide savings of 1 hour per 10 hour shift, or increase the number of packages delivered by a driver in a shift. In this way, the techniques and systems described herein allow for larger vehicles and reduced environmental impact in the fulfilment of package delivery, and also provide reduced congestion by both minimising the vehicle dwell time at any location and reducing the number of vehicles on the road.

In addition, by allowing a user to highlight a location subsequent to the vehicle entering the autonomous mode and prior to the vehicle moving, it is not required for the target location(s) to be determined and/or set before the user has arrived at the first location. In this way, the vehicle relocation system is more convenient for the user since they do not have to have planned the target location(s) ahead of time. In addition, the vehicle relocation system is more flexible since the target location(s) can be set in real time by the user, with knowledge as to the current state of a potential target location and the surrounding area.

Although the systems and techniques are generally described in relation to delivering parcels, it will be understood that they are not limited to this particular context, and may be used in other services where there is a high stop-start density involving human-vehicle interaction. For instance, the systems and techniques described herein may also be used in requesting vehicles in a port (e.g. yard shunters) or an airport (e.g. baggage handling trains) to travel to a target location.

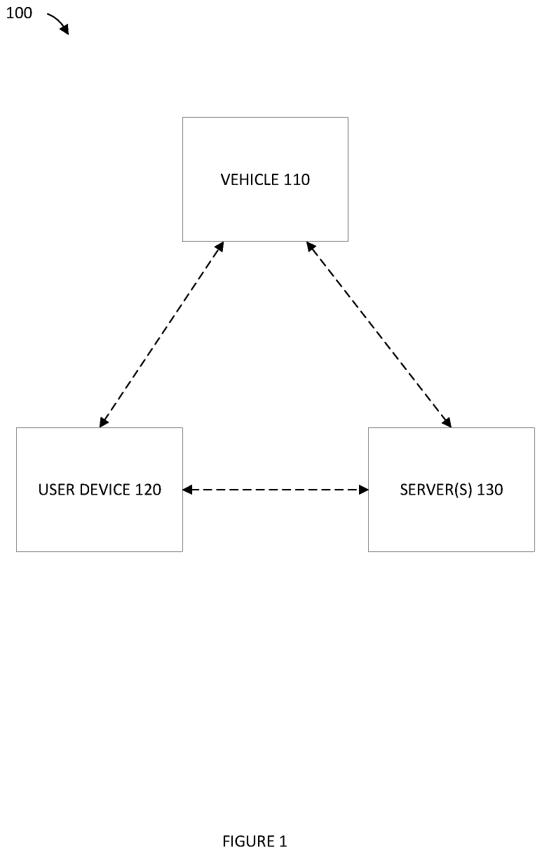

FIG. 1 illustrates an example of a vehicle relocation system 100. The vehicle relocation system 100 includes a vehicle 110 and a user device 120. In some examples, the vehicle relocation system 100 also includes one or more servers 130.

The vehicle 110 can be any type of vehicle which is capable of autonomously travelling to a target location without human supervision. The vehicle 110 is self-propelled, for instance, the vehicle 110 may be self-propelled by one or more of an electric motor and/or an internal combustion engine. The vehicle 110 may be powered by any suitable power source, for instance, battery, petrol, diesel, hydrogen fuel cell, etc.

The vehicle 110 may be a motor vehicle, e.g. an automobile, a van, a truck, a lorry, a bike, a trike, a bus, etc. In some examples, the vehicle 110 may be configured to operate on public roads. For instance, the vehicle 110 may be a delivery vehicle capable of carrying packages. In some other examples, the vehicle 110 may be configured to operate in environments other than public roads, such as airports, sea- or river ports, construction sites, etc. For instance, the vehicle 110 may be a baggage tug at an airport.

Alternatively, the vehicle 110 may be, for instance, a baggage cart, a trolley, etc. Alternatively, the vehicle may be a watercraft (e.g. a boat, a barge, etc.), an amphibious vehicle, or an aircraft (an airplane, a helicopter, a quad-copter, etc.).

The vehicle 110 is capable of both human/user controlled operation and autonomous operation. The vehicle 110 is capable of entering, from a human-controlled mode in which the vehicle 110 operates under human control, to an autonomous mode in which the vehicle 110 operates autonomously, i.e. without human control, and vice versa. The vehicle 110 can switch between modes responsive to a user input. The human controlled operation involves the user being physically present inside of the vehicle 110 to operate its controls. The autonomous mode may allow for the vehicle 110 to be empty, or, in other words, for no humans to be inside the vehicle 110 during autonomous mode operation.

The user device 120 is portable. For instance, the user device 120 may be of a size and weight which can be carried by a human. The user device 120 may be capable of operating when powered only by an internal power storage (e.g. a battery).

The user device 120 can be any type of device which can highlight a target location. For instance, the user device 120 may comprise a personal/mobile computing device, such as a smartphone, a tablet, a laptop, a mobile device, a wearable (e.g. head-mounted) computing device, etc. Additionally or alternatively, the user device 120 may comprise a programmable hardware device such as a key fob. Additionally or alternatively, the user device 120 may comprise a device capable of highlighting a target location via a beam of electromagnetic energy, such as a laser pointer, a torch, a flashlight, etc.

The one or more servers 130 comprise computing resources remote from the vehicle 110 and the user device 120. In some examples, one or more of the operations described herein may be performed by the one or more servers 130.

The one or more servers 130 may be in communication with the vehicle 110 and/or the user device 120. For instance, the server 130 and the vehicle 110 and/or the user device 120 are connected to a wireless network. For instance, the wireless network may be a cellular network. In some examples, one or more communications between the vehicle 110 and the user device 120 may be delivered via the one or more servers 130.

Additionally or alternatively, the vehicle 110 and the user device 120 may be in direct communication. In some examples, the vehicle 110 and the user device 120 may be connected to a local wireless network. For instance, the local wireless network may comprise a Bluetooth network, a Wi-Fi network, a ZigBee network, etc. In some examples, the vehicle 110 and the user device 120 may communicate directly, for instance via infrared messages, radio messages, etc.

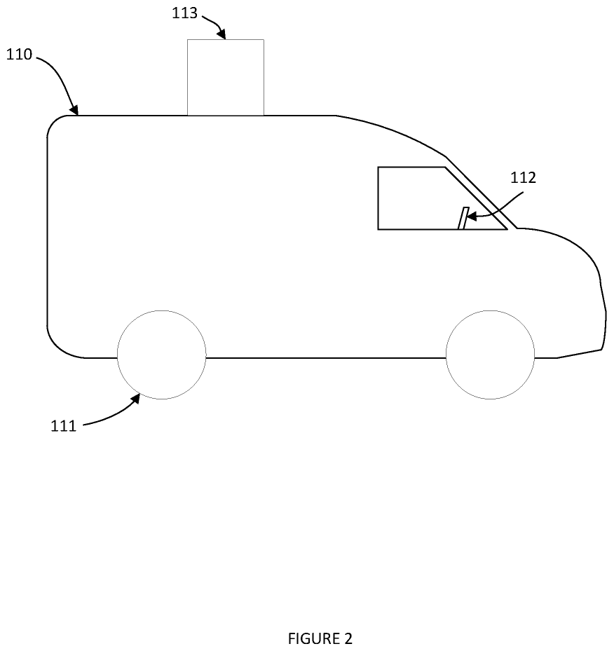

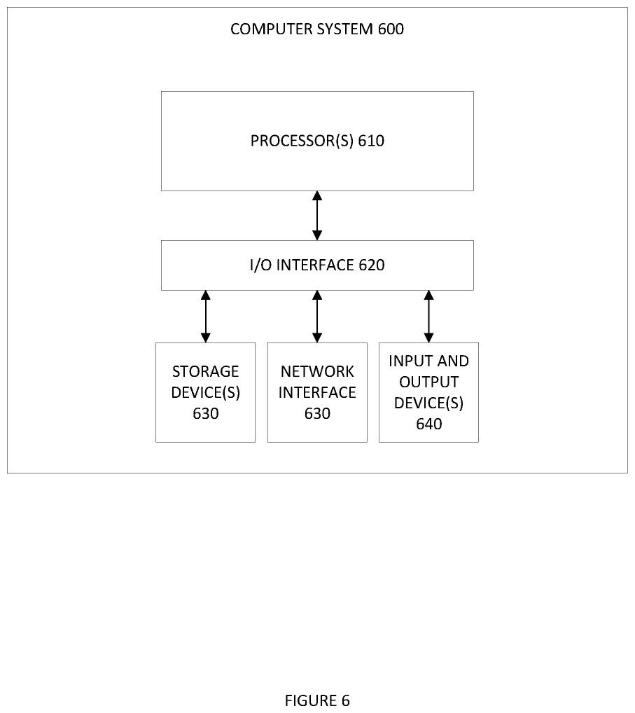

FIG. 2 illustrates an example of a vehicle 110 used in a vehicle relocation system. The vehicle 110 comprises wheels 111, one or more sensors 113, a steering wheel 112, and one or more computer systems (discussed below with reference to FIG. 6).

Although the vehicle 110 illustrated in FIG. 2 is a motor vehicle, it will be appreciated that the vehicle 110 is not limited to this, as discussed above. As such, although the vehicle 110 is illustrated as comprising wheels 111 in FIG. 2, the vehicle is not limited to this and may comprise any means of propulsion (e.g. tracks, propellers, etc.). In addition, although the vehicle 110 is illustrated as comprising a steering wheel 112, the vehicle 111 may comprise any means of vehicle control (e.g. button-type electrical switch, touch-sensitive display, levers, pedals, etc.).

The sensors 113 may comprise any type of sensors usable for autonomous driving capabilities. For instance, the sensors 113 may comprise one or more of an optical camera, a LIDAR, a stereo vision sensor, GNSS (e.g. GPS or Galileo), an IMU, infrared sensor, a roof mounted camera system, etc.

The sensors 113 may comprise any type of sensors usable for receiving an indication of a highlighted target location. As an example, when the target location is indicated by way of a laser pointer, the sensors 113 may comprise an optical camera capable of detecting the location at which the laser beam produced by the laser pointer encounters an object. In some examples, at least some of the sensors used to provide autonomous driving capabilities are also be used to receive the indication of the highlighted target location. In other examples, the sensors used to provide autonomous driving capabilities are different to those used to receive the indication of the highlighted target location.

In some examples, a top-down map view of the local environment may be generated based on sensor data captured by the sensors 113 (e.g. a 360 degree image). The generated top-down map view may be sent to the user device 120. The user can then highlight the target location on the top-down map view via a user input at the user device 120.

The computer systems of the vehicle 110 may be used to provide one or more operations discussed herein. The computing systems may comprise one or more means capable of communicating with the user device 110 and/or the servers 130.

The computer systems may provide the vehicle with autonomous driving capabilities. For instance, the computer systems may operate the steering wheel 112 and/or any other vehicle control means based on sensor data from the sensors 113, to control the wheels 111 of the vehicle 110 and thus autonomously travel from a first location to a second location.

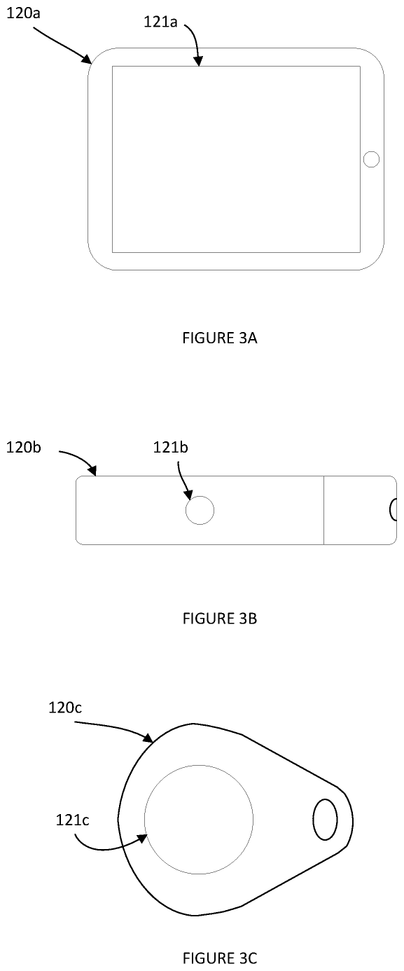

FIG. 3A illustrates an example of the user device 120 used in a vehicle relocation system. As illustrated in FIG. 3A, user device 120 may be a mobile computing device 120a. Although the mobile computing device 120a illustrated in FIG. 3A is shown as a tablet, as will be appreciated, the mobile computing device 120a is not limited to this example.

The mobile computing device 120a comprises one or more input devices 121a. Although FIG. 3A illustrates an example of a touch-sensitive display, it will be appreciated that the input devices 121a are not limited to this example. For instance, the input devices 121a may comprise one or more of a button-type electrical switch, a rocker switch, a toggle switch, a microphone, a camera, etc.

The mobile computing device 120a may comprise means to communicate with the vehicle 110 and/or the servers 130.

The mobile computing device 120a may comprise means to determine its current location. For instance, this may be achieved using one or more of GNSS (e.g. GPS or Galileo), Wi-Fi positioning system, Bluetooth 4.1 positioning, etc.

As an example, the mobile computing device 120a can be configured to determine its current location and communicate this current location to the vehicle 110. This may be performed in response to a user input via the input device 121a. The vehicle 110 then receives the current location from the mobile computing device 120a, and determines that the current location of the mobile computing device 120a is the target location. The communication of the current location may be an implicit request for the vehicle 110 to autonomously travel to the target location, or the vehicle 110 may be configured to wait for receipt of an explicit request from the mobile computing device 120a. Responsive to receiving the request, the vehicle 110 autonomously travels to the target location.

Continuing with this example, the user and/or the mobile computing device 120a may have, subsequent to sending the current location to the vehicle 110, moved to a new location. In this case, the target location for the vehicle 110 may not be updated based on the new location of the mobile computing device 120a. In this way, the user can, once they have requested the vehicle 110 travel to their current location, perform other activities without having to wait for or otherwise supervise the vehicle 110.

The mobile computing device 120a may also be configured to output information to a user, for instance via a display or a speaker. The information could be, for instance, a map, a list of locations, etc. The mobile computing device 120a may be configured to take as input, via the input devices 121a, a selection of a target location.

As an example, the mobile computing device 120a can display a map to the user. The map may be retrieved from storage of the mobile computing device 120a, the servers 130, etc. or may be generated by the vehicle 110 using the sensors 113. The user can select a target location on the map, for instance, by tapping a location on the displayed map on a touch-sensitive display. In response, the mobile computing device 120a provides an indication of the selected location to the vehicle 110. The vehicle 110 receives the selected location from the mobile computing device 120a, and determines that the selected location is the target location. The communication of the selected location may be an implicit request for the vehicle 110 to autonomously travel to the target location, or the vehicle 110 may be configured to wait for receipt of an explicit request from the mobile computing device 120a. Responsive to receiving the request, the vehicle 110 autonomously travels to the target location.

FIG. 3B illustrates another example of the user device 120 used in the vehicle relocation system. As illustrated in FIG. 3B, user device 120 may be a laser pointer 120b. The user device 120 may alternatively be any other device capable of highlighting a target location via a beam of electromagnetic energy. Additionally or alternatively, the user device 120 may comprise a laser pointer along with other components, such as a mobile computing device.

The laser pointer 120b may comprise one or more input devices 121b. Although FIG. 3B illustrates an example of a button-type electrical switch, it will be appreciated that the input devices 121b are not limited to this example. For instance, the input devices 121b may comprise one or more of a touch sensitive display, a rocker switch, a toggle switch, a microphone, a camera, etc.

The laser pointer 120b is configured to project a directed laser beam. For instance, the laser pointer 120b may be configured to project a laser beam responsive to user input via the input device 121b. The laser pointer 120b may be configured to project a laser beam which is identifiable (e.g. by the vehicle 110) as coming from the user device 120 of the vehicle relocation system 100.

In some examples, the laser pointer 120b may comprise means for communication with the vehicle 110. The input device 121b may be configured to cause communication with the vehicle 110. For instance, the laser pointer 120b may be configured to transmit an explicit request for the vehicle 110 to travel to the target location, or otherwise inform the vehicle 110 that the laser pointer 120b is projecting a directed laser beam or has done so. Additionally or alternatively, the laser pointer 120b may comprise means to determine its current location, e.g. by use of a GNSS receiver or Bluetooth 4.1-based positioning. The laser pointer 120b may be configured to communicate to the vehicle 110 its current location.

As an example, the user can point the laser pointer 120b at a location which they would like to highlight as the target location. The user can then cause the laser pointer 120a to project a laser beam, for instance via user input to the input device 121b. Assuming there is a clear line of sight between the laser pointer 120b and the desired target location (e.g. there are no obstacles between the laser pointer 120b and the desired target location), the first object that the beam of light projected by the laser pointer 120b will encounter will be at the desired target location, for instance, at a point in a road where the user would like the vehicle 110 to travel to and park. In this way, the target location can be highlighted by projecting, by the user device 120, a laser beam directed at the target location.

In some examples, the location at which the user directs the laser beam is not considered to be highlighted until one or more conditions are fulfilled. For instance, it may be required for the user to direct the laser beam at the location (or within a small area) for a predetermined amount of time (e.g. 1 second, 3 seconds, 10 seconds, etc.) before the location is deemed highlighted. This may be enforced by the vehicle 110. For instance, the vehicle 110 may not recognise the indication of the target location until it has detected that the laser beam has been directed at a particular area for a predetermined amount of time. Additionally or alternatively, a secondary user input via the one or more user input devices (121c) may be required to confirm the highlighting of the target location. Indication of the secondary user input may be provided to the vehicle 110, e.g. via communication of a message to the vehicle 110 and/or by modifying the laser beam projected by the laser pointer 120c. In this way, instances of accidental or erroneous target location highlighting can be reduced.

Continuing with the above example, the vehicle 110 is capable of, via one or more of its sensors 113, detecting the point at which the laser beam encounters an object, i.e. the point in the road. Responsive to detecting the point, the vehicle 110 may perform, for instance, image/signal processing and/or computer vision processes on the sensor data to recognise the physical location of the point at which the laser beam encounters an object. The vehicle 110 may determine the target location based on the location of the point at which the laser beam encounters an object. For instance, the vehicle 110 may determine that the point at which the laser beam encounters an object is the target location. In this case, the vehicle 110 is said to have received an indication of the target location. The vehicle 110 can then travel towards the highlighted location, and may be caused to park at or adjacent to the highlighted location. In some examples, the vehicle 110 is caused to autonomously park within a predefined area around the highlighted location. The location which the vehicle 110 ultimately parks may be chosen as a result of a determination of being suitable for parking the vehicle 110 (e.g. accessible to the vehicle 110, large enough space to accommodate the vehicle 110, legal to park the vehicle 110 according to the local laws and regulations, etc.). In this way, the vehicle 110 can find a suitable place to park (or more suitable than the precise location highlighted by the user) whilst fulfilling the user's instructions.

Additionally or alternatively, the vehicle 110 may make a determination as to whether there is a clear line of sight between the laser pointer 120b and the target location. As an example, the vehicle may determine whether there is a clear line of sight between the laser pointer 120b and the target location based on a communication from the laser pointer 120b indicating whether or not there is a clear line of sight between the laser pointer 120b and the target location. As another example, the vehicle 110 may make a determination that the point at which the laser beam encounters an object is not a suitable target location. For instance, the vehicle 110 may determine that it is not a suitable target location if the laser beam encounters a surface which is not a suitable angle or size for the vehicle to travel over (e.g. in the case of a delivery vehicle, where the laser beam encounters an object other than a road).

If the vehicle 110 makes a determination that there is a clear line of sight between the laser pointer 120b and the desired target location, the vehicle 110 may determine that the point at which the laser beam encounters an object is the target location. In this case, the vehicle 110 is said to have received an indication of the target location. On the other hand, if the vehicle 110 makes a determination that there is not a clear line of sight between the laser pointer 120b and the desired target location, the vehicle 110 may extrapolate, from the point at which the laser beam has encountered an object, where the intended target location is. This extrapolation may be based on determining, from the location of the laser pointer 120b and the point at which the laser beam encounters an object, the direction of the laser beam. The location of the laser pointer 120b may be communicated to the vehicle 110 and/or the vehicle may detect the location of the laser pointer 120b via one or more of its sensors 113. Once the vehicle 110 has extrapolated where the intended target location is, the vehicle 110 is said to have received an indication of the target location.

The highlighting of the target location by the laser pointer 120c may be interpreted as an implicit request for the vehicle 110 to autonomously travel to the target location, or the vehicle 110 may be configured to wait for receipt of an explicit request from the laser pointer 120c. Responsive to receiving the request (either implicitly or explicitly), the vehicle 110 autonomously travels to the target location.

In this way, the user can highlight a target location to the vehicle 110 intuitively and with a high degree of accuracy. The skill and training required to operate the system in this way is therefore very low. In addition, the user device 120 can be relatively simple and low cost.

Furthermore, in these examples, the user is able to highlight a location away from their current location. This provides additional flexibility as compared to implementations in which the user can only request the vehicle 110 to travel to their current location. In addition, the user can direct the vehicle 110 to travel to locations to which they do not have a direct line of sight, further improving the flexibility of the system.

The maximum distance at which the laser pointer 120c can highlight locations may be limited to a radius around the laser pointer 120c and/or the vehicle 110. For instance, the laser pointer 120c may be limited by the power of its output laser beam, the height of the user and/or the height at which they hold the laser pointer 120c, the terrain of the environment, the sensitivity of the sensors of the vehicle 110, the weather conditions, etc. The maximum distance may be enforced by the vehicle 110 and/or the servers 130, or may be a physical limitation of the components used. In some cases, the maximum distance at which the laser pointer 120c can highlight locations is between 10 and 100 metres.

In some examples, the user can direct the laser pointer 120c at landmarks near to the desired target location. The landmarks may be any object which protrudes from the ground or is otherwise more easily targeted with the laser beam from the laser pointer 120c by the user. The vehicle 110 may recognise that the user is directing the laser beam at a landmark, and subsequently determine that the target location is at or adjacent the targeted landmark.

As an example, the user wishes to direct the vehicle 110 to relocate to a certain location on a road, but does not have a direct line of sight of the desired point on the road (e.g. because they are too far away, or because there are obstacles impeding their line of sight). In this case, the user can instead direct the laser pointer 120c at a road sign (i.e. a landmark) adjacent to the desired point on the road to which they would like to relocate the vehicle which they do have a direct line of sight of. The vehicle 110 recognises that the laser beam is directed at a landmark rather than a target location (e.g. based on the vehicle 110 determining that it cannot park on the road sign) and thus determines that the target location is at a position on the road adjacent to the road sign. The vehicle 110 then autonomously travels to the target location.

In this way, difficulties with highlighting horizontal surfaces (such as roads) at distance, where the angle of incidence is low, can be avoided. As such, the maximum distance at which the user can accurately highlight target locations can also be increased. In addition, this provides the user another way to highlight target locations which they do not have a direct line of sight of. In this way, the flexibility of the system is further improved.

FIG. 3C illustrates another example of the user device 120 used in the vehicle relocation system. As illustrated in FIG. 3C, user device 120 may be a key fob 120c.

The key fob 120c comprises one or more input devices 121c. Although FIG. 3C illustrates an example of a button-type electrical switch, it will be appreciated that the input devices 121c are not limited to this example. For instance, the input devices 121c may comprise one or more of a touch sensitive display, a rocker switch, a toggle switch, a microphone, a camera, etc.

The key fob 120c may comprise means to determine its current location. For instance, this may be achieved using one or more of GNSS (e.g. GPS or Galileo), Wi-Fi positioning system, Bluetooth 4.1 positioning, etc. Additionally or alternatively, the key fob 120c may comprise means which allow one or more of the sensors 113 of the vehicle 110 to determine the location of the key fob 120c relative to the vehicle 110.

The key fob 120c may be configured to determine its current location and/or cause the vehicle 110 to determine its location relative to the vehicle in response to user input via the input device 121c. Alternatively or additionally, the key fob 120c may be configured to communicate, to the vehicle 110, an explicit request for the vehicle to travel to the target location and/or to communicate, to the vehicle 110, the current location of the key fob 120c. As has been described above in relation to FIG. 3A, responsive to the vehicle 110 receiving an indication of the current location of the key fob 120c and determining that the current location of the key fob 120c is the target location, the vehicle 110 may autonomously travel to the target location.

In some examples, the key fob 120c also comprises one or more user input devices 121c to lock and/or unlock doors of the vehicle 110.

Although the example of a key fob 120c is illustrated in FIG. 3C, it will be appreciated that the user device 120 is not limited to this example, and that the user device 120 could also be any device which can provide the functionality of described in relation to the key fob 120c.

In this way, the user device of the vehicle relocation system can be relatively simple. This means that the computational resource, energy, and functional requirements of the user device 120 are relatively low. In addition, the cost of the user device 120 can be kept relatively low.

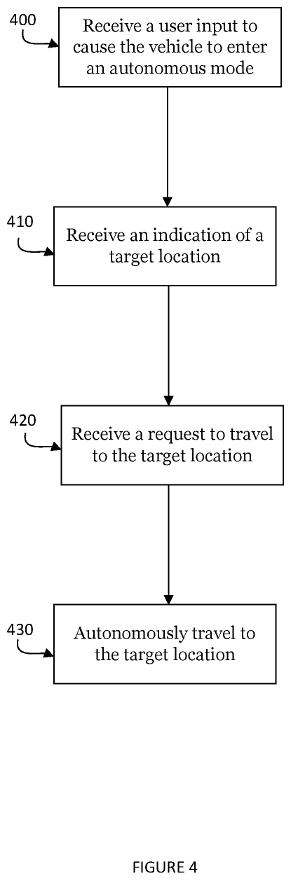

FIG. 4 is a flow chart illustrating an example of a method performed by a vehicle 110 in a vehicle relocation system. The operations may be performed by one or more of the computing systems of the vehicle 110. Additionally or alternatively, one or more of the operations may be performed by the servers 130.

At operation 400, the vehicle 110 receives a user input to cause the vehicle 110 to enter an autonomous mode. The vehicle 110 may be stationary when the user input is received. In some instances, it may be a requirement for the vehicle 110 to be stationary in order to enter an autonomous mode.

The user input may be an explicit indication, by the user, to enter an autonomous mode. For instance, the user input may comprise activation of a button-type electrical switch, a toggle switch, a voice command, etc. Additionally or alternatively, the user input may be implicit. For instance, the vehicle 110 may be configured to enter an autonomous mode when the user (or when the vehicle determines that the user) parks the vehicle 110, exits the vehicle 110, opens and closes a door of the vehicle 110, etc. Parking the vehicle 110 comprises, for instance, the user manoeuvring into a particular location with a suitable orientation, the user controlling the vehicle to come to a stop, the user applying one or more parking brakes, the user turning and/or removing a key from the vehicle, the user causing the vehicle to enter a standby mode, the user causing the gearing of the vehicle to disengage the wheels from an engine and/or motor of the vehicle, the user turning off an engine and/or motor of the vehicle, the user de-powering a motor and/or a driving system of the vehicle, the user exiting the vehicle, etc. The vehicle 110 may be configured to enter an autonomous mode in response to user inputs when one or more conditions are fulfilled. The conditions may be based on the context of the vehicle 110. For instance, the vehicle may be configured to enter an autonomous mode when the user provides the user input at certain times, at certain locations, on certain types of roads, etc.

In some examples, the user input may be provided at a device other than the vehicle 110 (e.g. user device 120), and subsequently communicated to the vehicle 110.

Entering the autonomous mode comprises switching from a human-controlled mode to an autonomous mode. The human-controlled mode is an operational mode of the vehicle 110 in which human control is required for the vehicle 110 to travel. The autonomous mode of the vehicle 110 is an operational mode of the vehicle 110 in which it travels without human control.

At operation 410, the vehicle 110 receives an indication of a target location.

Receiving an indication of the target location may comprise, receiving, from the user device 120, data indicative of the target location. For instance, the data indicative of the target location may be received over a local network, via a direct message from the user device 120, and/or from the user device 120 via the servers 130 as described above in relation to FIGS. 3A, 3B and 3C. The data indicative of the target location may be, for instance, coordinates, a name, a series of way points from the position of the vehicle 110, a signal indicating the direction and distance of the user device 120 relative to the vehicle 110, etc.

Additionally or alternatively, receiving an indication of the target location may comprise detecting, by a sensor 113 of the vehicle 110, a point in the environment which has been highlighted by the user device 120, as described above in relation to FIG. 3B.

At operation 420, the vehicle 110 receives a request to travel to the target location.

The request may be received from the from the user device 120. For instance, the request may be received over a local network, via a direct message from the user device 120, and/or from the user device 120 via the servers 130, as described above in relation to FIGS. 3A, 3B and 3C.

In some examples, the request is an explicit request for the vehicle 110 to travel to the target location. For instance, the request may be received separately from the indication of the target location. In these examples, the vehicle 110, after receiving the indication of the target location, may not move on to operation 430 until a request is received. In some other examples, the request is implicit. For instance, receipt of the indication of the target location is interpreted as a request for the vehicle 110 to travel to the target location. In these examples, the vehicle 110 may, after receipt of the indication of the target location, move on to operation 430 without subsequent communication with the user device 120.

At operation 430, the vehicle 110 autonomously travels to the target location.

Autonomously travelling to the target location comprises operating the means of propulsion of the vehicle 110 by the computer systems of the vehicle 110 without human control. As an example, autonomously travelling comprises autonomous operation of wheels, steering wheel, brakes, lights, etc. of the vehicle 110 such that the vehicle 110 can move from its previous location to the target location, without human control. Autonomously travelling may comprise travelling without a human present in the vehicle 110.

Autonomously travelling may comprise travelling on public roads. For instance, autonomously travelling may comprise complying with the laws and regulations of the public roads.

The vehicle 110 travels autonomously to the target location without human supervision. For instance, the vehicle 110 travels to the target location without a human having to watch the vehicle 110 as it travels. Additionally or alternatively, the vehicle 110 may autonomously travel to the target location without further communication with the user device 120.

The vehicle 110 may be configured to have a restricted speed limit when travelling autonomously. For instance, the vehicle 110 may be restricted to a top speed of 10 mph, 15 mph, or 20 mph when travelling autonomously. In this way, the safety of the vehicle's autonomous mode is increased.

Upon arriving at or near the target location (e.g. within a threshold distance), the vehicle 110 may proceed to autonomously park itself. The vehicle may autonomously park at the target location, or may autonomously park at a location within a predefined threshold distance of the target location. For instance, if the target location is in a car park, the vehicle 110 may autonomously park itself in a bay of the car park, even if this bay is not at the precise location of the target location. Autonomously parking may comprise complying with the laws and regulations of parking in the area in which the vehicle 110 is parking.

Upon arriving at or near the target location, the vehicle 110 may make a determination as to whether the target location is a suitable location to park. For instance, the vehicle 110 may determine that the target location is inaccessible to the vehicle 110. As an example, the vehicle 110 may determine that the target location is not suitable based on determining that the target area is occupied by another vehicle. Additionally or alternatively, the vehicle 110 may determine that the target location is not suitable based on determining that the target location is, for instance, too small for the vehicle 110, behind an impassable obstruction, at an incline not suitable for the vehicle 110, a location which would not be legal to park at (e.g. on a pavement), etc. The determination may be made by the computer systems of the vehicle based on, for instance, sensor data from its sensors 113 and/or data received from the servers 130.

When the vehicle 110 determines that the target location is a suitable location to park, the vehicle 110 may proceed to autonomously park at the target location.

When the vehicle 110 determines that the target location is not suitable, the vehicle 110 may communicate an indication that the target location is not suitable. For instance, the vehicle 110 may provide audio or light cues to indicate this (e.g. an alarm, activation of the horn, and/or flashing of the headlights). Additionally or alternatively, the vehicle 110 may send, to the user device 120, a message indicating that the target location is not suitable. For instance, the message may be sent over a local network, via a direct message to the user device 120, and/or to the user device 120 via the servers 130. The user device 120, responsive to receiving the message, may provide an output to alert the user that the target location is not suitable.

Additionally or alternatively, when the vehicle 110 determines that the target location is not suitable, the vehicle 110 may, for instance, attempt to find a nearby location to park and travel to the nearby location, wait for further instruction from the user, return to its previous location, etc.

In some examples, the vehicle 110 is capable of interpreting the indication of a target location as a request for the vehicle 110 to autonomously manoeuvre to a different orientation at approximately the same location. For instance, the user may highlight a location very close to the vehicles 110 location (i.e. just behind the vehicle 110), and the vehicle 110 may be caused to manoeuvre to a different orientation at approximately the same location (i.e. turn around 180 degrees). As an example, the user parks the vehicle 110 on a driveway, and then highlights a location to cause the vehicle 110 to turn around to allow for easier exiting of the driveway. Then, whilst the vehicle is manoeuvring, the user can continue with other activities, e.g. hand-delivering an item from the vehicle 110.

Once the vehicle 110 has travelled to the target location, it may remain stationary until it receives further input. For instance, the vehicle 110 may remain stationary until it receives an indication of a second target location and/or a request to travel to the second target location. In this way, operations 410 to 430 can be repeated.

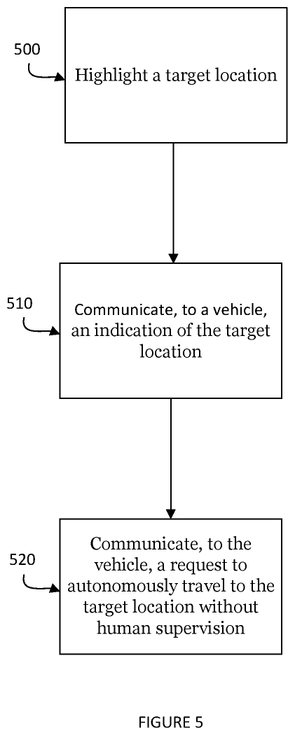

FIG. 5 is a flow chart illustrating an example of a method performed by a user device 120 in the vehicle relocation system. Additionally or alternatively, one or more of the operations may be performed by the servers 130.

At operation 500, the user device 120 highlights a target location.

In some examples, highlighting the target location comprises receiving, by the user device 120, a user input indicating a request for the vehicle 110 to travel to the user device 120; and determining that a location of the user device 120 at a time when the user input is received is the target location, as described in relation to FIGS. 3A, 3B and 3C. The user input may be, for instance, a touch input on a touch-sensitive display, a button-type electrical switch press, a voice command, a gesture, etc.

In some other examples, highlighting the target location comprises receiving, via a user input to the user device 120, an indication of the target location on a map, as described in relation to FIG. 3A. The user input may be, for instance, a touch input on a touch-sensitive display, a button-type electrical switch press, a voice command, a gesture, etc.

As an example, the user device 120 is a mobile computing device, and displays a map to the user on a touch-sensitive display of the mobile computing device. For instance, the mobile computing device may run a map application. The user can select a location on the map, for instance, by tapping a location on the map on the touch-sensitive display. The selected location is, in response to this user input, highlighted as the target location.

In yet further examples, highlighting the target location comprises projecting, by the user device 120, a laser beam directed at the target location, as described in relation to FIG. 3B. The user device 120 may project a laser beam in response to a user input. The user input may be, for instance, a touch input on a touch-sensitive display, a button-type electrical switch press, a voice command, a gesture, etc.

At operation 510, the user device 120 communicates, to a vehicle 110, an indication of the target location.

As an example, the user device 120 sends a message and/or signal indicating the target location to the vehicle 110. For instance, the message and/or signal may be sent over a local network, directly to the vehicle 110, and/or to the vehicle 110 via the servers 130.

The user device 120 may communicate the indication of the target location responsive to a user input. The user input may be, for instance, a touch input on a touch-sensitive display, a button-type electrical switch press, a voice command, a gesture, etc.

As another example, highlighting the target location in operation 500 also communicates, to the vehicle 110, an indication of the target location. For instance, the user device 120 may highlight the target location by projecting a laser beam directed at the target location. The vehicle 110 can then, based on sensor data from its sensors 113, detect the point at which the laser beam encounters an object, and from this point determine the target location, as described above in relation to FIG. 3B.

At operation 520, the user device 120 communicates, to the vehicle 110, a request to autonomously travel to the target location without human supervision.

The user device 120 may send a message explicitly requesting the vehicle 110 travel to the target location. For instance, the message may be sent over a local network, directly to the vehicle 110, and/or to the vehicle 110 via the servers 130. The request may be sent responsive to a user input. The user input may be, for instance, a touch input on a touch-sensitive display, a button-type electrical switch press, a voice command, a gesture, etc.

Additionally or alternatively, the request may be implicit. For instance, the request may be implied by the communication of the indication of the target location.

FIG. 6 is a schematic illustration of an example configuration of a computer system 600 which may be utilised to provide one or more of the operations described herein. For instance, the user device 120, the one or more computer systems of vehicle 110 and/or the servers 130 may comprise one or more computer systems 600.

In the example illustrated in FIG. 6, computer system 600 comprises one or more processors 610 communicatively coupled with one or more storage device(s) 630, a network interface 630, and one or more input and/or output devices 640 via an I/O interface 620.

The network interface 630 allows for wireless communications with one or more other computer systems. For instance, computer system 600 of the vehicle 110 can communicate with a computer system of the user device 120 and/or the server(s) 130 via their respective network interfaces 630.

The one or more input and output device(s) 640 allow for the computer system 600 to interface with the outside world. Examples of input devices include user input devices (e.g. a button-type electrical switch, a rocker switch, a toggle switch, a microphone, a camera, etc.), sensors, microphones, cameras, wired communications input, receivers, etc. Examples of output devices include displays, lights, speakers, wired communication output, etc.

The computer system 600 comprises one or more processors 610 communicatively coupled with one or more storage devices 630. The storage device(s) 630 has computer readable instructions stored thereon which, when executed by the processors 610 causes the computer system 600 to cause performance of various ones of the operations described with reference to FIGS. 1 to 5. The computer system 600 may, in some instances, be referred to as simply “apparatus”.

The processor(s) 610 may be of any suitable type or suitable combination of types. Indeed, the term “processor” should be understood to encompass computers having differing architectures such as single/multi-processor architectures and sequencers/parallel architectures. For example, the processor 610 may be a programmable processor that interprets computer program instructions and processes data. The processor(s) 610 may include plural programmable processors. Alternatively, the processor(s) 610 may be, for example, programmable hardware with embedded firmware. The processor(s) 610 may alternatively or additionally include one or more specialised circuit such as field programmable gate arrays FPGA, Application Specific Integrated Circuits (ASICs), signal processing devices etc. In some instances, the processor(s) 610 may be referred to as computing apparatus or processing means.

The processor(s) is coupled to the storage device(s) 630 and is operable to read/write data to/from the storage device(s) 630. The storage device(s) 630 may comprise a single memory unit or a plurality of memory units, upon which the computer readable instructions (or code) is stored. For example, the storage device(s) 630 may comprise both volatile memory and non-volatile memory. In such examples, the computer readable instructions/program code may be stored in the non-volatile memory and may be executed by the processor(s) 610 using the volatile memory for temporary storage of data or data and instructions. Examples of volatile memory include RAM, DRAM, and SDRAM etc. Examples of non-volatile memory include ROM, PROM, EEPROM, flash memory, optical storage, magnetic storage, etc.

The storage device(s) 630 may be referred to as one or more non-transitory computer readable memory medium. Further, the term ‘memory’, in addition to covering memory comprising both one or more non-volatile memory and one or more volatile memory, may also cover one or more volatile memories only, one or more non-volatile memories only. In the context of this document, a “memory” or “computer-readable medium” may be any media or means that can contain, store, communicate, propagate or transport the instructions for use by or in connection with an instruction execution system, apparatus, or device, such as a computer.

The computer readable instructions/program code may be pre-programmed into the computer system 600. Alternatively, the computer readable instructions may arrive at the computer system 600 via an electromagnetic carrier signal or may be copied from a physical entity such as a computer program product, a memory device or a record medium such as a CD-ROM or DVD. The computer readable instructions may provide the logic and routines that enables the computer system 600 to perform the functionality described above. The combination of computer-readable instructions stored on storage device(s) may be referred to as a computer program product. In general, references to computer program, instructions, code etc. should be understood to express software for a programmable processor firmware such as the programmable content of a hardware device as instructions for a processor or configured or configuration settings for a fixed function device, gate array, programmable logic device, etc.

Although various aspects of the methods and apparatuses described herein are set out in the independent claims, other aspects may comprise other combinations of features from the described embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims. The extent of protection is defined by the following claims, with due account being taken of any element which is equivalent to an element specified in the claims.

1. A method comprising:
receiving, at a stationary vehicle, a user input to cause the vehicle to enter an autonomous mode;
highlighting, by a portable user device, subsequent to the vehicle entering the autonomous mode and prior to the vehicle moving, a target location;
receiving, by the vehicle, an indication of the target location and a request to travel to the target location; and
causing the vehicle to autonomously travel to the target location without human supervision.

2. The method of claim 1, wherein highlighting the target location comprises:
receiving, by the user device, a user input indicating a request for the vehicle to travel to the user device; and
determining that a location of the user device at a time when the user input is received is the target location.

3. The method of claim 1, wherein the user device is a key fob.

4. The method of claim 1, wherein highlighting the target location comprises:
receiving, via a user input to the user device, an indication of the target location on a map.

5. The method of claim 1, further comprising:
generating, based on sensor data received from one or more sensors of the vehicle, a map of the area around the vehicle;
sending, to the user device, the generated map; and
receiving, via user input to the user device, an indication of the target location on the generated map.

6. The method of claim 1, wherein highlighting the target location comprises:
projecting, by the user device, a laser beam directed at the target location, and wherein receiving an indication of the target location comprises:
detecting, by a sensor of the vehicle, a point where the laser beam encounters an object; and
determining the target location based on the point.

7. The method of claim 6, wherein the point is the target location.

8. The method of claim 6, wherein determining the target location based on the point comprises:
determining that there is no line of sight between the user device and the target location; and
extrapolating, from the point and a location of the user device, the target location.

9. The method of claim 1, further comprising:
responsive to a determination by the vehicle that the target location is not a suitable location to park the vehicle, communicating an indication that the target location is not suitable.

10. The method of claim 9, wherein communicating the indication that the target location is not suitable comprises:
sending, to the user device, a message indicating that the target location is not suitable.

11. The method of claim 9, wherein determining that the target location is not a suitable location to park comprises determining that the target area is occupied by another vehicle.

12. The method of claim 1, further comprising:
subsequent to travelling to the target location, causing the vehicle to autonomously park within a predefined threshold distance of the target location.

13. The method of claim 1, wherein the vehicle is a delivery vehicle and the method is a method of operating a delivery vehicle, and autonomously travelling comprises navigating public roads to reach the target location.

14. The method of claim 1, wherein the user device and the vehicle communicate over a local network.

15. The method of claim 1, wherein the vehicle autonomously travels to the target location without further communication with the user device.

16. The method of claim 1, further comprising:
subsequent to causing the vehicle to autonomously travel to the target location:
highlighting, by the portable user device, a second target location;
receiving, by the vehicle, an indication of the second target location and a request to travel to the second target location; and
causing the vehicle to autonomously travel to the second target location without human supervision.

17. A system configured to perform the method of claim 1, the system comprising:
a vehicle; and
a portable user device.

18. A computer-readable storage medium comprising instructions which, when executed by one or more processors, cause the one or more processors to perform the method of claim 1.
